(19) United States
(12) Patent Application Publication
(10) Pub. No.: US 2026/0332511 A1
(43) Pub. Date: Oct. 22, 2026

(54) COMPUTATIONALLY EFFICIENT MULTI-PATH GRAPH TRAVERSAL WITH RUNTIME PATH MERGING

(71) Applicant: Degensoft Ltd, Dubai (AE)

(72) Inventors: Sergej Kunz, Dubai (AE); Ilia Zinovev, Odintsovo (RU)

(21) Appl. No.: 19/653,587

(22) Filed: Apr. 21, 2026

Related U.S. Application Data
(60) Provisional application No. 63/791,904, filed on Apr. 21, 2025.
(60) Provisional application No. 63/866,810, filed on Aug. 19, 2025.

(51) Int. Cl. H04L 45/00; H04L 45/24

(52) U.S. Cl. CPC H04L 45/14; H04L 45/24

(57) ABSTRACT

A computer system may receive a request to convert a quantity of a first digital asset into a second digital asset and may construct a directed graph of possible conversion paths through intermediate assets. The system may compute predicted weights for intermediate nodes using a price up parameter and actual weights for the target node without the price up parameter. Computational acceleration techniques, such as a predictor algorithm or a dynamic weight algorithm, may reduce path evaluation time. The system may select paths by solving a knapsack problem with mutual exclusivity constraints and may recursively refine selections by updating predicted weights with actual weights. When two or more selected paths pass through a common intermediate node, the system may identify that node as a merge point and aggregate asset volumes from the converging paths, enabling a single combined operation from the merge point rather than separate operations for each path.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57. This application claims the benefit of U.S. Provisional Patent Application No. 63/791,904, entitled “SWAP SYSTEMS AND METHODS,” filed Apr. 21, 2025, and U.S. Provisional Patent Application No. 63/866,810, entitled “SWAP SYSTEMS AND METHODS,” filed Aug. 19, 2025, each of which is incorporated herein by reference in its entirety.

### BRIEF DESCRIPTION OF THE DRAWINGS

Detailed descriptions of implementations of the present invention will be described and explained through the use of the accompanying drawings.

FIG. 1 illustrates an example of a multiple path swap according to some embodiments.

FIG. 2 illustrates a more efficient multi-path swap according to some implementations of the present disclosure.

FIG. 3 illustrates an example swap from token A to token F according to some implementations.

FIGS. 4-11 illustrate example trees and weights according to some implementations.

FIGS. 12-14 illustrate flowcharts of methods according to some implementations.

FIG. 15 is a system diagram depicting a system for reducing on-chain transaction costs in multi-path cryptocurrency token swap transactions according to some implementations.

FIG. 16 is a block diagram depicting an embodiment of a computer hardware system configured to run software for implementing one or more of the systems and methods described herein.

The technologies described herein will become more apparent to those skilled in the art from studying Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Although several implementations, embodiments, examples, and illustrations are disclosed below, it will be understood by those of ordinary skill in the art that the present disclosure extends beyond the specifically disclosed embodiments, examples, and illustrations and includes other uses and obvious modifications and equivalents thereof. Implementations are described with reference to the accompanying figures, wherein like numerals refer to like elements throughout. The terminology used in the description presented herein is not intended to be interpreted in any limited or restrictive manner simply because it is being used in conjunction with a detailed description of certain specific implementations. In addition, implementations can comprise several novel features, and no single feature is solely responsible for its desirable attributes or is essential to practicing the present disclosure.

Cryptocurrency swaps can be used to exchange one type of cryptocurrency for another, without needing to convert to a fiat currency, such as US dollars or Euros, as an intermediate step. Cryptocurrency swaps can enable traders, investors, and others to move between different types of digital assets and manage their portfolios without needing to utilize fiat currencies. This can be advantageous as any intermediate transfers may incur costs or have other drawbacks, such as increasing overall transaction times, increasing computational workloads, and so forth.

Cryptocurrency swaps can work in various ways. With centralized exchanges, users deposit cryptocurrency into accounts managed by the centralized exchange, and the exchange manages conversion from one type of cryptocurrency to another, for example in an internal market. Such a model relies on trusting the centralized exchange to manage funds, execute trades in a fair manner, and ensure security. Decentralized exchanges, in contrast, can operate without a central intermediary, for example using smart contracts on a blockchain. Some decentralized exchanges utilize liquidity pools that hold reserves of two or more tokens. Users can provide liquidity by depositing assets into pools and can earn fees in return. Swaps can be executed against the pools. The cost of executing a swap can depend on the number, ratio, or both, of tokens in the pool. Costs can also be influenced by factors such as the volume of tokens being swapped. Rather than trusting a company, as in the case of a centralized exchange, users instead trust the underlying blockchain and smart contract code, and users can retain control of their tokens, private keys, etc. Another option for performing swaps is the use of atomic swaps. With atomic swaps, swaps are exchanged between different blockchains without reliance on an intermediary. Atomic swaps can use hashed timelock contracts (HTLCs), a type of smart contract that the recipient of a payment must acknowledge by a deadline by generating proof of payment, thereby ensuring that a swap either succeeds or fails completely.

Cryptocurrency swaps are used in many circumstances to provide various benefits, such as improving efficiency by avoiding conversion to and from fiat currencies, enabling access to a wider range of tokens, more easily managing portfolios (e.g., rebalancing), and working with decentralized finance protocols that may require specific tokens.

While there are many benefits and uses for cryptocurrency swaps, there are several challenges, such as slippage (e.g., when the final execution price differs from the expected price when a swap was initiated), transaction costs, and so forth. Executing swaps can involve interacting with smart contracts on a blockchain. These interactions consume computational resources and incur network fees, often referred to as gas fees. Gas fees can vary based on factors such as network congestion. Gas fees and other transactions costs can be prohibitively large, especially for smaller swaps. For example, the total fee for a swap can be based on complexity, demand, and/or urgency. Simple transfers from one wallet to another are low complexity and thus tend to incur lower gas fees, while swaps typically involve smart contracts, checking liquidity pools, determining price impacts, and moving multiple tokens, resulting in higher gas fees. There can also be base fees driven by demand. Each block has limited transaction space, and the cost for space can go up when there is high demand. In some cases, fees can include a priority fee or “tip” to speed up a swap by making it more likely that validators will pick up the swap. Scaling solutions and alternative chains can mitigate high gas and other transaction fees to some degree, but transaction costs remain a significant issue.

As described above, swaps involve exchanging one token type for another. This can be done directly in some cases but often involves intermediate tokens. The individual transactions to get from a starting token to a target token can be complex and varied, and different paths can have significantly different transactions costs associated with them. In some cases, paths can share some common features. For example, two different paths may both utilize the same intermediate token, while other intermediate tokens in the paths can be different. Treating paths completely independently can incur higher fees and places increased demands on computational systems executing the swap.

The present disclosure describes approaches for improved swaps. More specifically, this disclosure describes approaches for merged swaps, in which multiple token swap paths are merged into a single intermediary token, and held swaps, which can improve the use of concentrated liquidity even in circumstances in which maximum volume limits are imposed. A held swap is a feature where a trade is not fully executed in a single step. Instead, a portion of the tokens is held at an intermediate node, which allows a system to wait for tokens arriving from other complex paths. In some implementations, when merging is advantageous, certain transactions may be delayed. For example, one execution path may pause while another execution path catches up to a particular merge point.

In some cases, there are capacity limitations or other issues that result in a swap being split into multiple smaller swaps which proceed along different execution paths, decentralized exchange protocols, or both. A large swap that is executed entirely through a single liquidity pool could change the token ratio in the pool significantly, resulting in a worse execution price than expected. Such swaps may even be forbidden in some cases, for example to ensure that a liquidity pool maintains an acceptable ratio of different tokens. Splitting a swap across multiple paths, performing intermediate swaps, or both, can result in a better net price in some circumstances, for example depending upon the particular fees charged at each swap. A routing algorithm can be configured to split swaps along multiple paths, to perform one or more intermediate swaps, or both, in order to optimize a swap transaction (e.g., to minimize the network fees associated with the swap transaction).

The present disclosure describes approaches for graph traversal and optimization in order to improve the efficiency of swaps. In some implementations, the graph traversal and optimization processes described herein may be accelerated using computational acceleration techniques. For example, a predictor algorithm and a dynamic weight algorithm can address a technical challenge in blockchain swap optimization: the graph traversal and weight calculation process may involve evaluating a large number of candidate paths, each requiring multiple computations involving liquidity data, gas cost data, exchange rate data, etc., from multiple decentralized exchange markets. Without computational acceleration, the time required to evaluate all candidate paths may exceed the time window within which the underlying market conditions remain valid. The predictor algorithm can address this by predicting the outcomes of paths that have not yet been fully evaluated based on patterns observed in paths that have been evaluated, thereby reducing the number of full path evaluations that need to be performed. The dynamic weight algorithm can address this issue by propagating weight information from evaluated path segments to unexplored paths that share common segments, thereby avoiding redundant recalculation of shared path segments. These techniques can reduce the total computation time for path optimization, enabling the system to identify and execute optimized swap paths within the time constraints imposed by blockchain block times and rapidly changing market conditions, while also conserving computational resources

In some implementations, the predictor algorithm operates by observing the relationship between predicted weights and actual weights for paths that have already been fully evaluated and using this relationship to estimate the actual weights of paths that have not yet been fully evaluated. For example, the predictor algorithm may observe that for a particular type of intermediate node (e.g., a node representing a token with high liquidity), the actual weight tends to be within a certain percentage of the predicted weight. The predictor algorithm may apply this observed relationship to estimate the actual weight of an unexplored path passing through a similar intermediate node, without requiring the system to perform a full recursive deepening for that path. In some implementations, the dynamic weight algorithm may operate by identifying segments that are shared between an evaluated path and an unexplored path and propagating the weight information from the shared segments of the evaluated path to the unexplored path. For example, if an evaluated path passes through nodes A→B→C→Y and an unexplored path passes through nodes A→B→D→Y, the dynamic weight algorithm may reuse the weight information for the A→B segment rather than recalculating it. In some implementations, the dynamic weight algorithm maintains a cache of weight calculations for previously evaluated segments and look up cached results when the same segment appears in a new path.

When multiple swap paths are used to complete a cryptocurrency swap on a blockchain network, each individual swap along each path may require a separate smart contract invocation. Each smart contract invocation consumes computational resources on the blockchain network and incurs a gas fee. When multiple paths overlap at one or more intermediate tokens, conventional approaches that treat each path independently result in redundant smart contract invocations at the overlapping points for example, two separate smart contract calls to convert the same type of intermediate token to the target token, when a single smart contract call processing the combined volume could achieve the same result. These redundant smart contract invocations waste computational resources on the blockchain network and impose unnecessary gas fees on the user. The approaches described herein address this technical problem by identifying merge points where multiple paths converge on a common intermediate token and aggregating tokens from the converging paths before executing a single smart contract call from the merge point, thereby reducing the total number of smart contract invocations on the blockchain network and the associated gas fees.

A significant limitation of some current approaches to performing swaps is that when multiple paths are used to complete a swap, the multiple paths may overlap at one or more points. However, many approaches treat different paths as being entirely independent of one another. This can result in inefficient processing and increased gas consumption. The approaches herein can enable more computationally efficient swaps than some other approaches. Swaps performed according to the present disclosure may also incur lower transaction costs.

In some implementations, the system identifies merge points by analyzing the selected candidate paths to detect nodes that appear in two or more paths. For example, if a first selected path passes through nodes A→C→D→F and a second selected path passes through nodes A→B→D→F, the system may identify node D as a merge point because both paths pass through node D. In some implementations, the system may identify multiple merge points along a set of paths. In some implementations, the system may evaluate each potential merge point to determine whether merging at that point would produce a net benefit, considering factors such as the per-operation cost savings from executing a single combined operation versus the potential price impact of a larger combined volume.

Some existing approaches to multi-path swap optimization use techniques such as gradient descent or dynamic programming to determine favorable paths between a source token and a target token. These approaches may evaluate multiple paths and distribute swap volumes across different exchanges to reduce slippage. However, such approaches generally treat each path as an independent sequence of transactions from the source token to the target token, without recognizing or exploiting opportunities to merge paths that share common intermediate tokens. As a result, when two or more independently-optimized paths happen to pass through the same intermediate token, each path executes its own separate swap transaction at that intermediate token, resulting in duplicated smart contract invocations and duplicated gas fees. The approaches described herein differ from such independent-path approaches by actively identifying points where multiple paths converge on a common intermediate token and merging the paths at those points, so that a single swap transaction can be executed from the merge point using the combined token volume from all converging paths.

In addition to runtime path merging, the approaches described herein may differ from some existing approaches in several other respects. For example, some implementations described herein distinguish between predicted weights and actual weights during graph traversal, using a price up parameter for intermediate nodes to account for uncertainty in capacity availability, and recursively updating predicted weights as actual weights are obtained through deeper graph traversal. Some existing approaches use a single weight calculation without distinguishing between predicted and actual weights and without recursively refining weight estimates as the graph is traversed. Some implementations described herein formulate the path selection problem as a knapsack problem with mutual exclusivity constraints, in which at most one part allocation can be selected per candidate node. Some existing approaches use gradient descent or standard dynamic programming without such a constrained knapsack formulation. Some implementations described herein implement held operations in which execution of one path is temporarily paused at an intermediate node while the system monitors for the arrival of assets from another path, enabling runtime coordination of paths that may arrive at a shared intermediate node at different times. Some existing approaches execute all paths independently without pausing or coordinating execution timing between paths. Some implementations described herein account for already-invoked exchange venues when calculating the incremental cost of a merge operation, such that the per-operation cost for exchange venues already invoked in a confirmed hop is not counted again when additional volume is routed through the same hop. Some existing approaches do not account for previously-invoked exchange venues and may therefore overestimate the cost of routing additional volume through a shared hop.

The present disclosure provides several benefits over some other approaches. For example, the approaches described in the present disclosure can enable users to better understand how their transactions are executed and which tokens are involved, and can enable simpler, cheaper, and/or more transparent swap transactions. The approaches described herein can improve returns by utilizing multiple swap paths, which can be combined to secure optimized rates. In some implementations, the approaches herein provide for improved liquidity efficiency by splitting volumes into smaller chunks and blending paths. In some implementations, the techniques herein can utilize more diverse liquidity pools, for example distributing volume to capture better rates. In some implementations, the approaches herein merge paths for improved efficiency.

While the approaches described herein are illustrated in the context of cryptocurrency token swaps on blockchain networks, the underlying techniques may be applicable to other domains involving multi-path routing through a graph of intermediate nodes where operations at each node incur per-invocation costs. For example, in some implementations, the path merging and held operation techniques may be applied to cross-chain bridge optimization, where transfers across different blockchain networks pass through common intermediate chains or wrapped tokens, and aggregating transfers at shared intermediate points may reduce the total number of bridge invocations and associated fees. In some implementations, the techniques may be applied to payment routing in multi-hop payment channel networks, where payment flows through shared intermediate nodes may be aggregated to reduce the total number of channel updates and routing fees. In some implementations, the techniques may be applied to supply chain logistics, where shipments traveling along multiple routes through shared intermediate hubs (e.g., ports or distribution centers) may be consolidated at those hubs to reduce handling fees and transportation costs. In some implementations, the techniques may be applied to network packet routing, where data packets traveling along multiple paths through shared intermediate routers may be aggregated to reduce per-packet overhead and routing table lookups, and the held operation concept may correspond to buffering packets at an intermediate node while waiting for related packets from other paths. In some implementations, the techniques may be applied to multi-venue securities order routing, where order fragments converging on a common intermediate venue or clearing entity may be aggregated to reduce per-transaction clearing and settlement fees. In some implementations, the techniques may be applied to energy grid load balancing, where power flows routed through multiple paths via shared intermediate substations may be aggregated to reduce switching costs and transmission losses. In some implementations, the techniques may be applied to cloud computing task scheduling, where processing jobs split across multiple compute paths with shared intermediate data stores may be aggregated at those stores to reduce I/O operations and data transfer costs.

As used herein, the terms ‘market,’ ‘liquidity pool,’ ‘exchange venue,’ and ‘routing venue’ may be used interchangeably to refer to any venue, platform, protocol, or mechanism capable of executing an exchange or conversion operation between two assets. The terms ‘gas fees,’ ‘gas costs,’ ‘transaction costs,’ ‘per-operation costs,’ and ‘per-invocation costs’ may be used interchangeably to refer to any cost incurred by invoking an exchange or conversion operation at a venue. The term ‘liquidity’ may be used interchangeably with ‘capacity’ to refer to the ability of a venue to process a given volume of an exchange operation. The term ‘blockchain network’ is one example of a ‘distributed transaction network’ or ‘transaction network,’ and the techniques described herein may be applied to any distributed transaction network in which operations at intermediate nodes incur per-invocation costs. The terms ‘swap,’ ‘exchange,’ and ‘operation’ may be used interchangeably to refer to a conversion of one asset for another.

FIG. 1 illustrates an example of a multiple path swap according to some embodiments. In FIG. 1, a swap from a first token (A) to a second token (B) is executed along a first path 120 and a second path 125. The first path 120 can include swapping token A to token C, then swapping token C to token D, then swapping token D to token B. Along the second path 125, token A is swapped to token E, which is swapped to token D, which is swapped to token B. A fraction of the total number of A tokens can be processed along the first path 120, and the remainder can be processed along the second path 125. As shown in FIG. 1, both first path 120 and second path 125 involve converting from token D to token B; however, these swaps are done separately, meaning that there are two gas fees associated within converting from token D to token B.

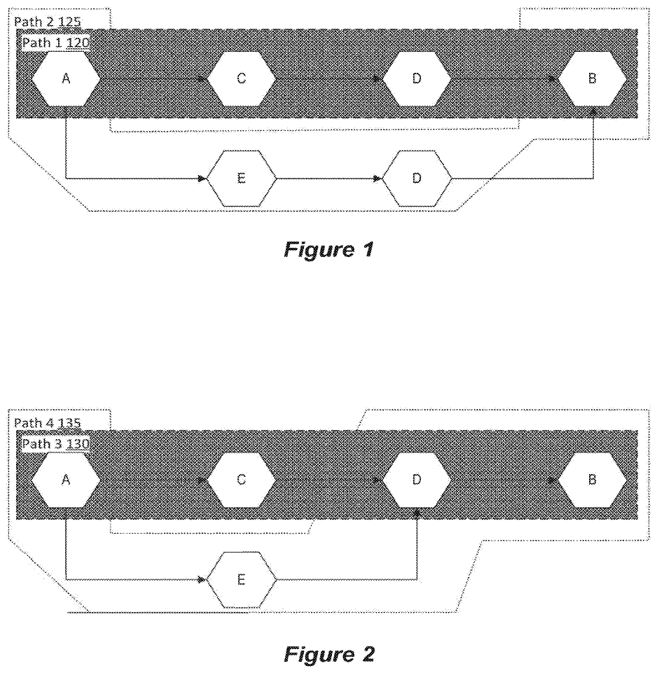

FIG. 2 illustrates a more efficient multi-path swap according to some implementations of the present disclosure. In FIG. 2, a third path 130 and fourth path 135 merge prior to completion, and the D tokens from both third path 130 and fourth path 135 can be converted to token B in a single transaction, thereby reducing gas fees. By executing fewer transactions, the process shown in FIG. 2 can be both more computation efficient than that shown in FIG. 1 and can provide an improved end result (e.g., more Token B). While optimization is shown for the last step (e.g., token D to token B) in FIG. 2, it will be appreciated that such optimizations can be applied at any point, and that there can be more than one point where the paths merge. The paths shown in FIG. 2 can represent paths that reduce or eliminate redundant steps and optimize gas consumption, for example by using the most profitable market(s) for the merged final path.

In some implementations, the approaches herein can optimize (e.g., maximize) the use of concentrated liquidity, even in circumstances where maximum volume limits are imposed (e.g., as described herein, there may be volume limitations intended to prevent a liquidity pool from becoming unbalanced). The advantages of an approach as described herein can become especially clear when trading through market makers and limit orders, where the available volume is capped.

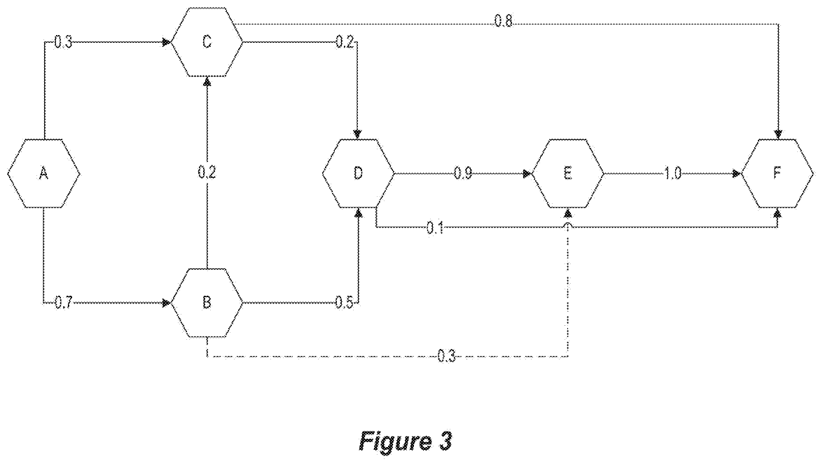

FIG. 3 illustrates an example swap from token A to token F, for example from USDC to WBTC. However, it may not be most efficient (or in some cases, even possible) to go directly from token A to token F). As shown in FIG. 3, a portion of token A can be swapped to token B (70%), and another portion can be swapped to token C (30%). A portion of token B (20%) can be swapped to token C, and another portion (50%) can be swapped to token D. As shown by the dashed line, 30% of token B is unused. Token E can be the same type of token as token B. A portion of token C (20%) can be converted to token D, while another portion is converted to token F (80%). In FIG. 3, 10% of token D is converted to token F, while the remaining 90% is converted to token E (which can be the same type as token B). The token E converted from token D, along with the leftover token B (both of which can be, for example, UDSC), can then be converted to token F. Thus, multiple paths are followed to convert from token A to token F. The paths can be selected to minimize gas cost.

The paths illustrated in FIG. 3 are merely examples, and it will be appreciated that other paths are possible. In general, paths can be selected to optimize for gas consumption while being constrained by limitations (e.g., liquidity, volume limits) for conducting specific swaps. In some implementations, paths are selected using a graph that maps possible transaction paths along with constraints on each path (e.g., constraints on particular swaps performed along each path), and paths can be selected to minimize the cost of the swaps, to minimize the execution time (e.g., by preferring fewer swaps or faster swaps), to minimize computational resources needed to perform the swaps, or any combination thereof. For example, in some cases, a user may want a swap to be carried out quickly and thus may accept somewhat more expensive set of swap paths, while in other cases, a user may not be in a rush for the swap to complete and may opt to use longer, slower, and/or more numerous paths to minimize cost.

Direct swaps are swaps that convert from a first token to a second token, without intermediate transformations to another token. In a direct swap of token X to token Y, there may be several markets capable of executing the swap. Each market has a certain amount of available liquidity and a price curve. Market price curves are typically convex or, in relatively uncommon circumstances, linear. Thus, the price for exchanging one token for another may worsen as the swap volume increases. The gas cost for invoking a market, on the other hand, is often static or nearly static regardless of volume.

As an example, consider swapping 100 X tokens for Y tokens, possibly using up three markets M1, M2, and M3 that can perform the swap. It is desirable to find that combination of M1, M2, and M3 that results in the greatest number of Y tokens for the user.

Table 1 shows an example calculation for optimizing swaps on M1, M2, and M3.

TABLE 1

| | Part 1 | Part 2 | Part 3 |
|---|---|---|---|
| Market | (input 100/3) | (input 100/3*2) | (input 100) |
| M1 | 35 (38 t-3 g) | 60 (63 t-3 g) | 82 (85 t-3 g) |
| M2 | 35 (40 t-5 g) | 65 (70 t-5 g) | 85 (90 t-5 g) |
| M3 | 29 (44 t-15 g) | — | — |

In Table 1, Part 1 represents a first trade for a first part of the tokens in which M1 has the lowest token cost. One third of the X tokens can be swapped for Y tokens on M1, netting 35 Y tokens (38 Y tokens minus a gas cost of 3 Y tokens). The other two thirds are swapped in a second transaction on M2 to yield 65 Y tokens, for a total yield of 100 Y tokens and a cost of 8 gas.

The approach becomes more complicated when there are intermediate swaps. In such cases, graph traversal can be used to determine optimal transactions to carry out. Direct swap calculations can be used to determine weights from one node to another in the graph representation.

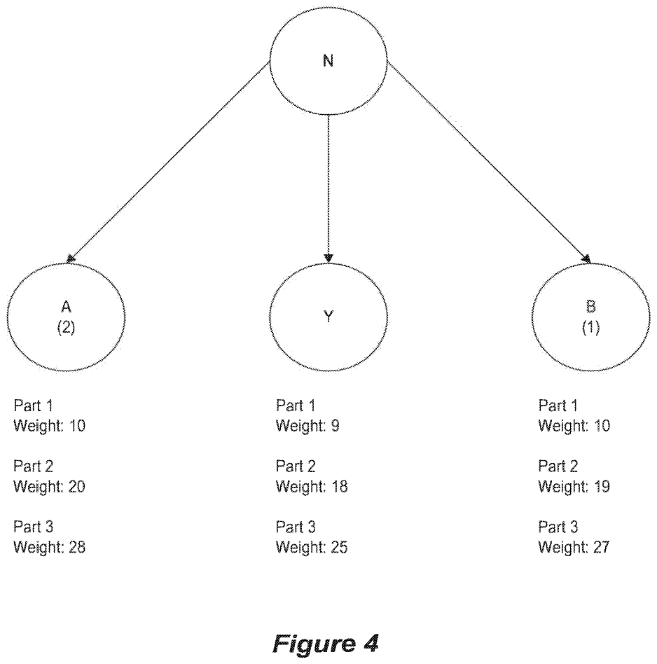

Graph traversal can be used to determine optimized transaction paths. Each path can include one or more hops, with each hop representing a distinct transaction, which can be an intermediate transaction or a final transaction. There is generally a large number of possible paths. In some implementations, a “route parts” parameter is used to place limitations on graph traversal. For example, route parts can be an adjustable parameter that defines how many ways an input can be split. As an example, if a user has token N equivalent to 30 ETH and route parts equals three, then from node N, the input can split into three parts, and a system can calculate the number of tokens that can be obtained for each part. The token amounts can be converted to ETH equivalent, and gas costs can be subtracted. The result of this process can be defined as the weight. This concept is illustrated in FIG. 4.

Once the weights are determined, the system can proceed to solving the knapsack problem to find the best combination of weights. The solving can be limited by the constraint that the solution cannot exceed or fall short of the number of parts defined by route parts. Additionally, the solution can be constrained by only being able to select one combination per node (e.g., Part 1 and Part 2 from node A are mutually exclusive, and only at most one can be selected). In the example of FIG. 4, a “part” is defined as (part number)/(route parts) of the total available tokens to be swapped. Thus, for example, in the case of route parts equal to three, Part 1 represents one third of the tokens to be swapped, Part 2 represents two thirds of the tokens to be swapped, and Part 3 represents the case where all the tokens are swapped.

In the example of FIG. 4, the greatest result is obtained by choosing Part 2 from node A and Part 1 from node B, which gives a total output of 30 ETH.

It can be significant to distinguish between predicted weights and actual weights. For example, consider swapping a token (node N) into a target token (node Y). When calculating the value obtained at node Y and converting it to a baseline equivalent (e.g., to ETH equivalent), the system obtains the actual weight—the real number of tokens that can be obtained. However, for intermediate nodes (e.g., any node except the target and starting nodes), the system can calculate a predicted weight. The weight is predicted because there is uncertainty and no guarantee that an intermediate node has sufficient liquidity to ensure a lossless transition to the target node.

Moreover, there is no guarantee that losses will or will not occur when passing through an intermediate node. In some cases, the weight may increase due to favorable trading conditions. This is generally rare for large values, but common for small-to-medium values. In some implementations, when calculating a predicted weight, the system can include a price up. The price up can be a dynamic parameter that can be adjusted based on various factors including, for example, value. Thus, a final weight formula can be (token amount in baseline (e.g., ETH) equivalent−gas costs for market usage)*(price up), where price up is typically around 1.05 (e.g., a 5% price up). When a node is the target node, then the price up parameter is not applied (e.g., price up is set to 1).

Returning to distribution, once the system has identified an optimal weight combination, the system can proceed further, recursively repeating steps to determine the actual paths to be taken. The weights can be calculated from the selected nodes with the chosen number of route parts.

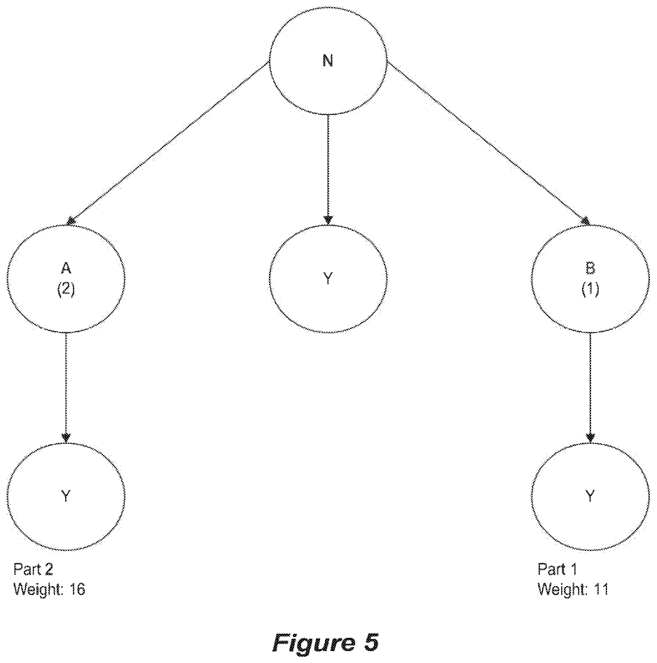

As an example, suppose nodes A and B in FIG. 4 have no connections to other intermediate nodes, only to the target node Y. The system can calculate the actual weight from nodes A and B to node Y, as illustrated in FIG. 5. Since there are no alternative paths beyond the target node, the system can end the recurve deepening and return one level up to update the weights obtained from this deepening. In the example of FIG. 5, node A has an updated weight of 16 for Part 2, and node B has an updated weight of 11 for Part 1.

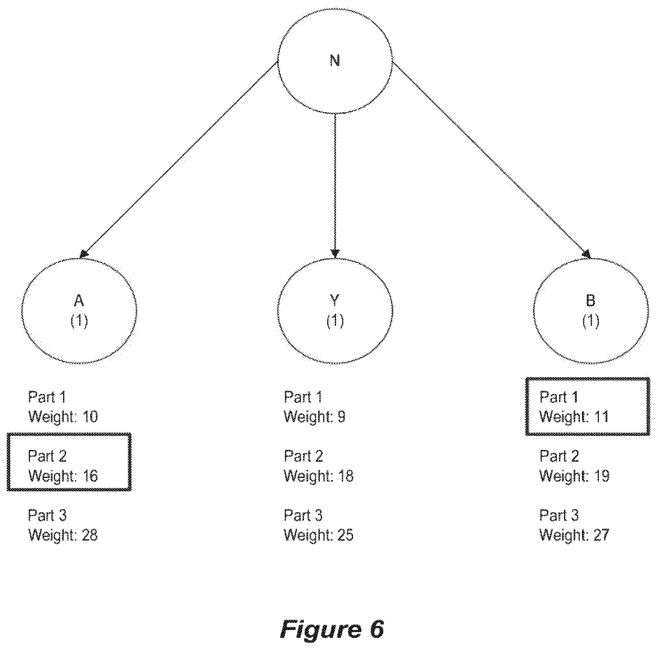

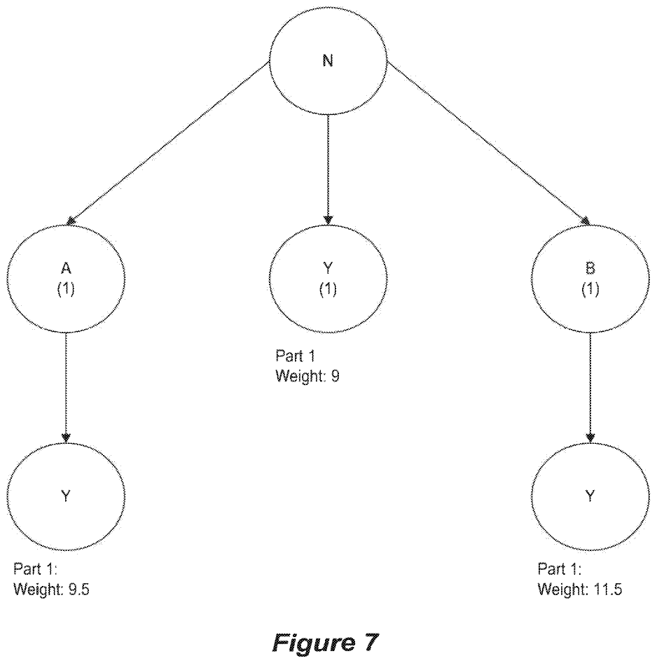

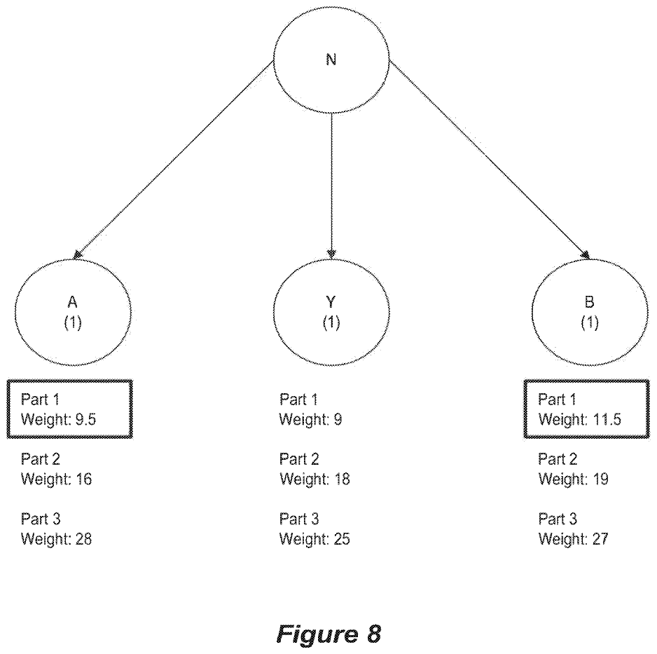

The system can then re-evaluate the most profitable combination using the updated weights. As shown in FIG. 6, when updated with the actual weights, the best combination is to utilize three paths, one part to node A, one part to node Y, and one part to node B. The system can carry out the process a second time to obtain the weights shown in FIG. 7 and then update the weights as shown in FIG. 8.

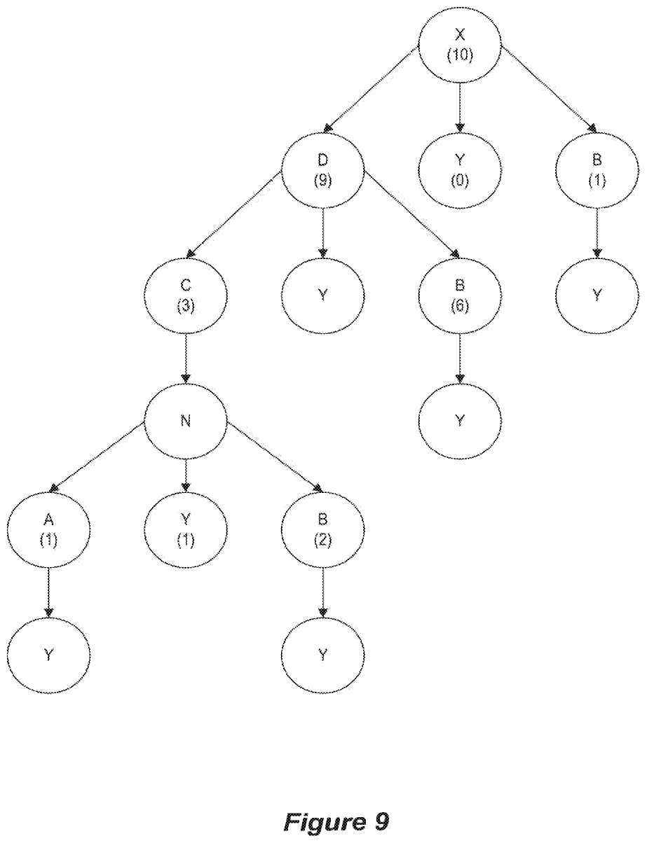

Having gathered the most profitable combination of actual weights, the system can update the weight of node N, considering this to be the actual weight. The final weight of node N in the example illustrated in FIG. 8 is 9.5+9+11.5=30. Node N can be the initial node or can be an intermediate node in another deepening. For example, FIG. 9 shows a more complex scenario in which node N is an intermediate node.

In the example of FIG. 9, the path B to Y is used three times (X→B→Y; X→D→B→Y; X→D→C→N→B→Y). Suppose that the hop B→Y only has one market capable of performing the swap. This creates a scenario in which the paths conflict for the use of this market.

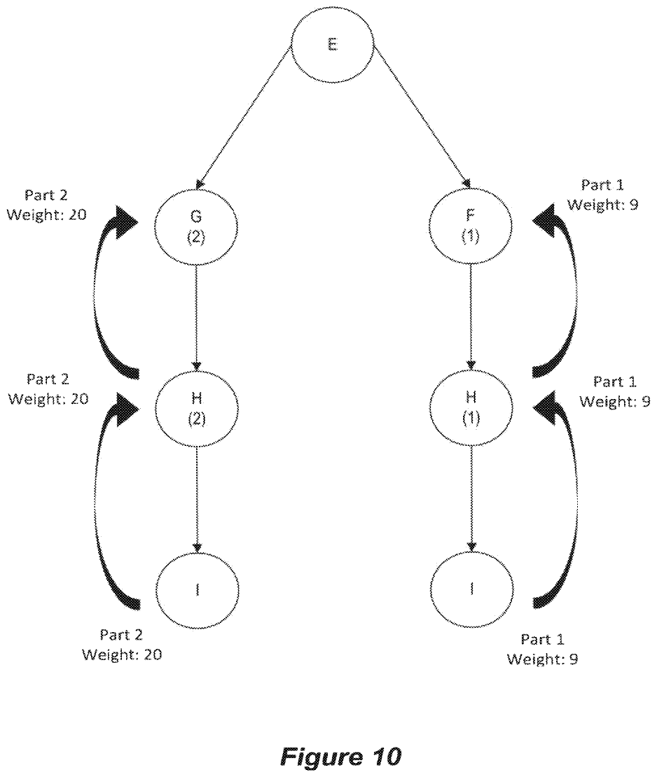

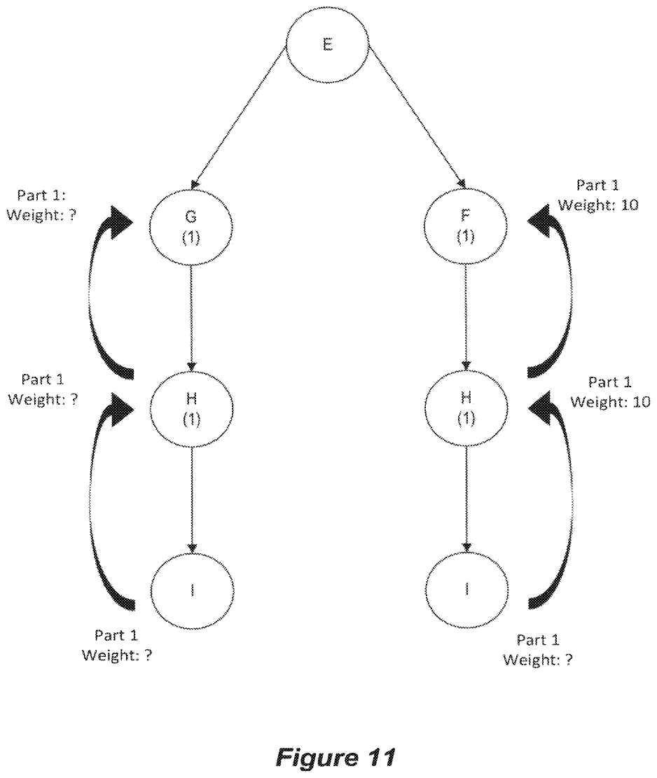

Some implementations merge paths. In some implementations the system determines which path takes priority for a given hop. When reaching the target token (obtaining the actual weight), the system updates the weights of intermediate parent nodes. In the example of FIG. 10, the best combination of actual weights has been determined, and there is a conflict in the hop H→I. Each node contains can include information about confirmed paths. If node E was the starting node, this information is not empty. Having returned to node E with the best distribution of actual weights, the system can select the path with the highest weight and confirm it. In the example of FIG. 10, the path with the highest weight is E→G→H→I.

In some implementations, the system saves (confirms) the distribution details for each hop in the path. As an example, the system can save information such as:

### E→G:

Hop Input: 20 token E
Hop Output: 25 token G
Gas Used: 2
Markets Used: [ . . . ]

### G→H:

Hop Input: 25 token G
Hop Output: 19 token H
Gas Used: 1
Markets Used: [ . . . ]

### H→I

Hop Input: 19 token H
Hop Output: 26 token Y
Gas Used: 3
Markets Used: [ . . . ]

In the above example, two out of three parts are allocated to this path. One part remains. Thus, the system can restart the algorithm to find the best combination from node E with only one part, as shown in FIG. 11. Node E now has information about occupied paths.

For the hops E→F and F→H, nothing has changed. However, for other hops, the system now has information that a certain number of tokens has already been processed. For example, for the hop E→G, the system has information about the confirmed distribution: 20 E tokens were processed to obtain 25 G tokens, spending 2 gas in the process. Next, the system can calculate the weight of node G when processing 10 tokens on this path, where 20 tokens have already been processed. The system can combine the confirmed input with the new input, totaling 30 E tokens, and calculate the distribution for 30 tokens.

As an example:

### E→G

Hop Input: 30 token E
Hop Output: 32 token G
Gas Used: 2
Markets Used: [ . . . ]

The system can subtract the previously-confirmed output from the new output: 32−25=7, and subtract the confirmed gas from the current gas: 2−2=0. Thus, the system can determine that processing one part through the hop E→G yields 7 tokens with zero gas spent. The gas spent is zero in this example because combining the input amount used the same markets, for which gas was already paid in the previously confirmed hop. If additional markets were used during the merge, the system would only account for the gas of invoking those markets.

In some implementations, gas savings and potential slippage are calculated as separate items. Some implementations calculate a total net outcome for each potential action, which can inherently balance the two factors. For example, a system can be aware of the price impacts of trade size and factor this into calculations. A larger, merged trade might result in a less favorable exchange rate, for example, and therefore a lower token output compared to two smaller, separate trades.

In some implementations, a merge is treated as a simple combination of the input amount and recalculation. The result of the previously calculated hop distribution is subtracted from the combined distribution, and the remainder is the result of the merged distribution.

In the above example, it will be appreciated that when the system calculated the best combination for node E with three parts, it had already computed the distribution for the hop E→G with three parts. However, the optimal distribution used two parts. By adding one part, the system effectively calculates the distribution for three parts. Thus, the path E→G→H→I with one part in this example is not new—it is equivalent to merging to merging with E→G→H→I with two parts, which is the same as E→G→H→I with three parts.

The above discussion is merely an example. Other scenarios can also take place. For example, consider a merge on the path E→F→H→I, where the system had originally allocated one part. Previously, the system obtained a final node weight of 10 on this path, but now the hop H→I is occupied by another path. The system can perform as merge operation. As a result, the path may become more profitable (e.g., because there is no need to pay additional gas for invoking markets on H→I) or less profitable (e.g., because the market rate worsens due to partial liquidity exhaustion by the other path).

One approach to different paths using the same hop is to distribute markets between the two paths, so each path could only use specific markets allocated to it. A merge approach provides several advantages over such a market distribution approach. For example, merging can have lower gas costs when using markets already invoked, increased liquidity (e.g., because both paths can use a market with high liquidity), and so forth.

The graph traversal algorithm described herein has several characteristics. The graph traversal algorithm can prioritize exploring paths with the highest weight until the weight becomes actual (e.g., until the target node is reached). In some implementations, the graph traversal algorithm utilizes dynamic programming to determine the best combination for distributed parts to child nodes (paths). For example, a system can split tokens from one node to others. In some implementations, the system can, after finding the best combination with actual weights, select the path with the highest weight, confirm it, and restart the algorithm steps with the remaining parts. In some implementations, new weight calculations account for confirmed hop distributions. Each node can receive confirmed path information from its parent and pass confirmed child path information to the parent when the best combination among its children is found. If the node and its child paths are all confirmed, they can join the parent's confirmed distribution. The graph traversal process can end when all route parts are confirmed for the initial node.

Additionally, several advanced optimization techniques are used in some implementations. Without such optimizations, a graph traversal algorithm may not operate sufficiently quickly. Some examples of optimization techniques include a predictor algorithm that predicts path outcomes and a dynamic weight algorithm that updates weights for unexplored paths based on known weights of other (e.g., larger) path segments. These optimizations can enable significant performance boosts. For example, the predictor algorithm can speed up processing by an average of 5×, and the dynamic weight algorithm can speed up processing by up to 3× in some implementations.

In some implementations, a held swap involves temporarily holding tokens at an intermediate node in a swap path while the system waits for tokens arriving from one or more other paths to reach the same intermediate node. The system may monitor the progress of multiple execution paths and determine when sufficient tokens have arrived at the merge point to proceed with a combined transaction. In some implementations, the system may implement timeout mechanisms such that if tokens from a second path do not arrive at the merge point within a configurable time threshold, the system may proceed with executing the swap using only the tokens that have arrived, or may reroute the held tokens along an alternative path. In some implementations, the held swap mechanism may include a fallback strategy in which, if conditions change (e.g., liquidity conditions at the merge point deteriorate), the system may release the held tokens and execute them independently rather than waiting for the merge. The decision of whether to hold tokens or proceed independently may be based on a comparison of the expected gas savings from merging versus the potential cost of delay (e.g., price movement risk during the hold period).

In some implementations, path merging occurs during execution of the swap transaction, not merely during the planning phase. The system may identify merge points where two or more execution paths converge on a common intermediate token, and may aggregate tokens from the converging paths at the merge point before executing a single combined swap transaction from the merge point onward. This runtime merging may reduce the total number of on-chain transactions compared to executing each path independently, thereby reducing total gas consumption. In some implementations, the system may identify multiple merge points along a set of paths, and may perform merging at each such merge point. The selection of merge points may be based on factors such as the gas cost savings achievable by merging, the liquidity available at the merge point, the expected timing of token arrivals from different paths, and the potential price impact of a larger merged transaction versus smaller independent transactions.

In some implementations, the optimization problem is formulated as a variant of the knapsack problem in which the system selects a combination of path parts from multiple candidate nodes, subject to the constraint that the total number of selected parts equals the route parts parameter. The mutual exclusivity constraint means that for each candidate node, at most one part allocation (e.g., Part 1, Part 2, or Part 3) can be selected, because selecting Part 2 for a node inherently includes the volume that would have been allocated by Part 1. In some implementations, the system may use a bounded knapsack formulation or a 0/1 knapsack formulation. In some implementations, the system may use heuristic or approximation algorithms to solve the knapsack problem when the number of candidate nodes or route parts is large, in order to maintain computational efficiency. The route parts parameter may be adjustable, and increasing the route parts parameter may increase the granularity of the optimization but may also increase computational cost.

In some implementations, the system maintains and updates predicted weights as execution progresses through the graph. When the system recursively deepens into a subgraph and obtains actual weights for intermediate nodes, the system may update the predicted weights of parent nodes based on the actual weights obtained from the recursive deepening. This update process may cause the system to re-evaluate and potentially change the optimal path selection. In some implementations, the price up parameter used in predicted weight calculations may be dynamically adjusted based on historical data, such as the historical accuracy of predicted weights for similar swap volumes or similar token pairs. In some implementations, the price up parameter may be different for different intermediate nodes based on factors such as the liquidity depth of the node, the volatility of the token represented by the node, or the number of available markets at the node. In some implementations, the system may track discrepancies between predicted and actual weights over time and use this information to improve future predictions.

In some implementations, the recursive weight recalculation process involves the system first identifying an optimal weight combination at a given level of the graph, then recursively deepening into each selected node to obtain actual weights, and then returning to the parent level to update the weights and re-evaluate the optimal combination. This process may repeat multiple times as the system works through the graph from the starting node toward the target node. In some implementations, the system may employ memoization to cache intermediate results and avoid redundant calculations during the recursive process. In some implementations, the recursive process may terminate when a maximum recursion depth is reached, when all route parts have been confirmed, or when the difference between predicted and actual weights falls below a threshold. Confirmed path information may propagate bidirectionally: a parent node may pass confirmed path information to its children (so that children can account for already-occupied markets), and children may pass confirmed path information back to the parent (so that the parent can update its weight calculations). This bidirectional propagation of confirmed path information may enable the system to account for interactions between paths that share common hops or markets.

In a market distribution approach, when two paths share a common hop, the available markets at that hop may be divided between the two paths such that each path can only use its allocated subset of markets. This market distribution approach may result in suboptimal outcomes because each path is restricted to a smaller set of markets, potentially resulting in worse exchange rates and higher slippage. In contrast, the merge approach described herein may allow both paths to use all available markets at the shared hop by combining the token volumes from both paths into a single merged transaction. This may result in lower gas costs (because markets that have already been invoked do not need to be invoked again), access to greater liquidity (because both paths can benefit from high-liquidity markets), and potentially better exchange rates (because the system can optimize the distribution across all available markets for the combined volume). In some implementations, the system may evaluate both the merge approach and the market distribution approach for a given set of conflicting paths and select the approach that yields the better net outcome.

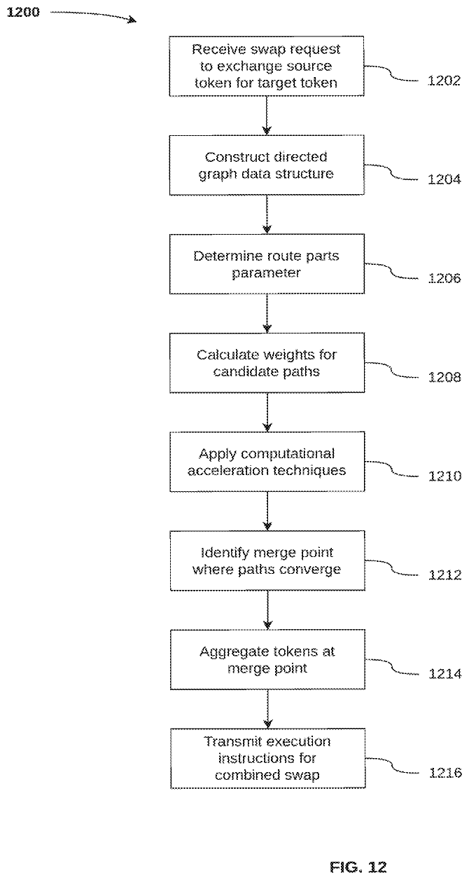

FIG. 12 illustrates a flowchart of a method 1200 for reducing on-chain transaction costs in multi-path cryptocurrency token swap transactions on a blockchain network. At operation 1202, the system can receive a swap request to exchange a quantity of a source token for a target token. At operation 1204, the system can construct a directed graph data structure comprising nodes representing tokens and edges representing swap operations between tokens. At operation 1206, the system can determine a route parts parameter that defines a number of portions into which the quantity of the source token is to be divided. At operation 1208, the system can calculate weights for candidate paths through the directed graph, including predicted weights for intermediate nodes and actual weights for target nodes. At operation 1210, the system can apply computational acceleration techniques, such as a predictor algorithm or a dynamic weight algorithm, to reduce computation time. At operation 1212, the system can identify a merge point where two or more candidate paths converge on a common intermediate token. At operation 1214, the system can aggregate tokens from the converging paths at the merge point. At operation 1216, the system can transmit execution instructions to a blockchain network to execute a single combined swap transaction from the merge point, thereby reducing the total number of smart contract invocations and associated gas fees.

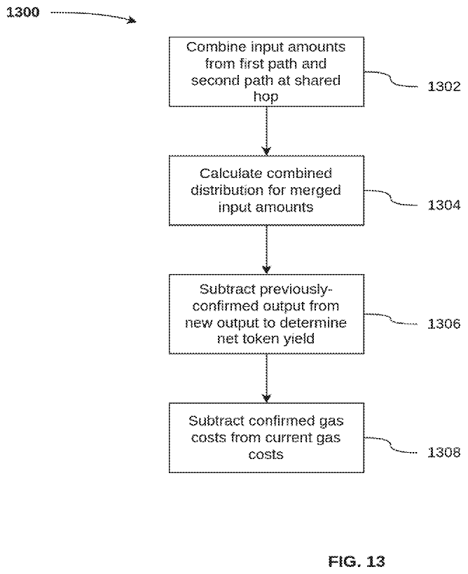

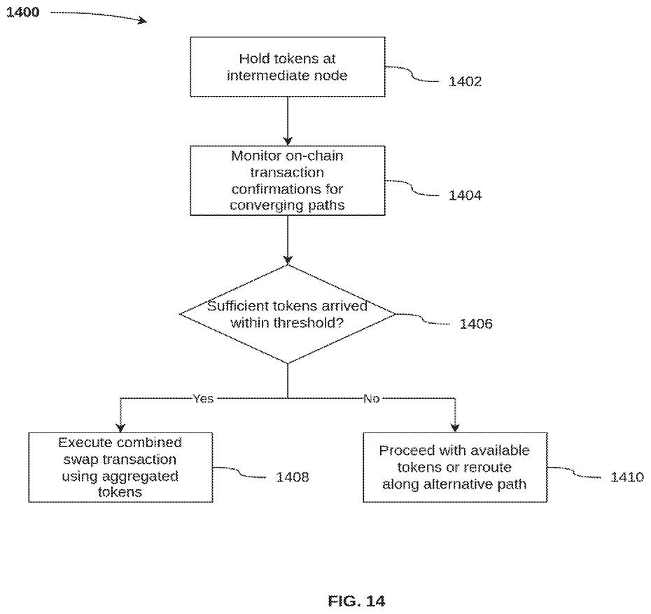

FIG. 13 illustrates a flowchart of a method 1300 for performing a merge operation on multi-path cryptocurrency swap transactions. At operation 1302, the system can combine input amounts from a first path and a second path at a shared hop. At operation 1304, the system can calculate a combined distribution for the merged input amounts. At operation 1306, the system can subtract a previously-confirmed output from a new output to determine a net token yield. At operation 1308, the system can subtract confirmed gas costs from current gas costs, wherein gas costs for markets already invoked in a confirmed hop are not counted again.

FIG. 14 illustrates a flowchart of a method 1400 for implementing a held swap mechanism in multi-path cryptocurrency token swap transactions. At operation 1402, the system can hold tokens at an intermediate node in a swap path. At operation 1404, the system can monitor on-chain transaction confirmations for converging paths to determine when tokens from other execution paths are arriving at the intermediate node. At decision 1406, the system can determine whether sufficient tokens have arrived at the intermediate node within a configurable time threshold. If sufficient tokens have arrived, the system can proceed to operation 1408, where a combined swap transaction can be executed using the aggregated tokens from the converging paths. If sufficient tokens have not arrived within the threshold, the system can proceed to operation 1410, where the system can proceed with executing a swap using only the tokens that have arrived or reroute the held tokens along an alternative path.

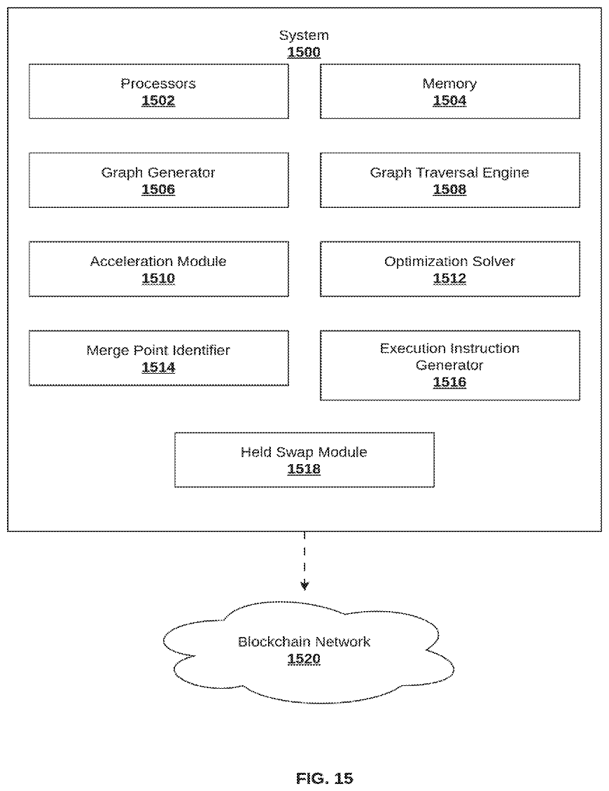

FIG. 15 is a system diagram depicting a system 1500 for reducing on-chain transaction costs in multi-path cryptocurrency token swap transactions on a blockchain network. The system 1500 can include hardware components such as one or more processors 1502 and memory 1504. The system can include various software or firmware components that execute on the hardware components. A graph generator 1506 generates a graph representation of available swap paths, wherein the graph representation comprises nodes representing tokens and edges representing swap operations. The graph generator 1506 provides the graph representation to a graph traversal engine 1508 that applies a graph traversal algorithm to identify candidate paths, prioritizing paths with highest predicted weights. The graph traversal engine 1508 communicates with an acceleration module 1510, which applies computational acceleration techniques including a predictor algorithm and a dynamic weight algorithm. An optimization solver 1512 receives output from the graph traversal engine 1508 and solves a constrained optimization problem to select a combination of path parts subject to a route parts constraint. A merge point identifier 1514 identifies merge points where selected candidate paths share a common intermediate token. The merge point identifier 1514 and the optimization solver 1512 can provide inputs to an execution instruction generator 1516 that generates execution instructions aggregating tokens from multiple paths at each merge point. A held swap module 1518 communicates with the execution instruction generator 1516 to manage temporarily holding tokens at intermediate nodes while awaiting tokens from other execution paths. The system 1500 can transmit execution instructions to a blockchain network 1520. This is merely an example of various modules and how they can interact. It will be appreciated that there can be different modules, fewer modules, or additional modules, and that the specific interactions between modules can differ while still being consistent with the present disclosure.

### EXAMPLES

Implementation 1. A computer-implemented method for optimizing multi-path routing through a weighted directed graph data structure to reduce per-operation costs in a distributed transaction network, the method comprising: receiving, by one or more processors, a routing request specifying a source node, a target node, and a quantity to be routed from the source node to the target node; constructing, by the one or more processors, a directed graph data structure comprising a plurality of nodes and a plurality of edges connecting the nodes, wherein each edge is associated with one or more routing venues having capacity data and per-operation cost data; determining, by the one or more processors, a route parts parameter that defines a number of portions into which the quantity is to be divided for routing through the directed graph data structure; calculating, by the one or more processors, a weight for each of a plurality of candidate paths through the directed graph data structure, wherein calculating the weight comprises: computing a predicted weight for each intermediate node based on a quantity amount converted to a baseline equivalent minus per-operation costs multiplied by a price up parameter that accounts for uncertainty in capacity availability at the intermediate node; and computing an actual weight for the target node based on a quantity amount converted to the baseline equivalent minus per-operation costs without applying the price up parameter; applying, by the one or more processors, one or more computational acceleration techniques comprising at least one of: a predictor algorithm that predicts path outcomes based on patterns observed in previously evaluated paths to reduce a number of full path evaluations required; or a dynamic weight algorithm that propagates weight information from evaluated path segments to unexplored paths sharing common segments to avoid redundant recalculation; formulating, by the one or more processors, a constrained optimization problem as a knapsack problem in which a combination of path parts from multiple candidate nodes is selected subject to a constraint that a total number of selected parts equals the route parts parameter and a mutual exclusivity constraint such that for each candidate node at most one part allocation is selected; recursively deepening, by the one or more processors, into selected paths to obtain actual weights by calculating outputs at the target node without the price up parameter; propagating, by the one or more processors, actual weight information from child nodes to parent nodes to update predicted weights and re-evaluating path selections based on the updated weights; identifying, by the one or more processors, one or more merge points where two or more selected candidate paths converge on a common intermediate node; generating, by the one or more processors, execution instructions that aggregate quantities from the two or more selected candidate paths at each merge point and execute a single combined operation from each merge point; and transmitting, by the one or more processors, the execution instructions to the distributed transaction network, wherein the execution instructions cause fewer operation invocations on the distributed transaction network than would be required to execute each selected candidate path independently.

Implementation 2. The computer-implemented method of implementation 1, wherein the distributed transaction network comprises a blockchain network, the source node and the target node represent cryptocurrency tokens, the routing venues comprise decentralized exchange liquidity markets, and the per-operation costs comprise gas fees for smart contract invocations.

Implementation 3. The computer-implemented method of implementation 1, further comprising: detecting a conflict where two or more selected candidate paths require use of a same routing venue at a shared edge; confirming a path with highest actual weight among the conflicting paths by storing distribution data for each hop in the confirmed path, the distribution data comprising input quantity, output quantity, per-operation cost incurred, and routing venue identifiers; and restarting the constrained optimization problem for remaining route parts while incorporating the stored distribution data into weight calculations for paths sharing hops with the confirmed path.

Implementation 4. The computer-implemented method of implementation 1, further comprising: implementing a held operation by temporarily holding a quantity at an intermediate node while monitoring transaction confirmations on the distributed transaction network indicating that a second execution path is progressing toward the intermediate node; determining when sufficient quantity has arrived at the intermediate node from the second execution path; and executing a combined operation from the intermediate node using aggregated quantities from converging execution paths.

Implementation 5. A computer-implemented method for reducing per-invocation costs in multi-path digital asset exchange operations on a transaction network, the method comprising: receiving, by one or more processors, an exchange request to exchange a quantity of a source asset for a target asset; constructing, by the one or more processors, a directed graph data structure comprising nodes representing assets and edges representing exchange operations between assets, wherein each edge is associated with one or more exchange venues; determining, by the one or more processors, a route parts parameter that defines a number of portions into which the quantity of the source asset is to be divided; calculating, by the one or more processors, weights for candidate paths through the directed graph data structure, wherein calculating the weights comprises computing predicted weights for intermediate nodes and actual weights for the target asset; applying, by the one or more processors, one or more computational acceleration techniques to reduce computation time for identifying the candidate paths, the one or more computational acceleration techniques comprising at least one of a predictor algorithm that predicts path outcomes or a dynamic weight algorithm that updates weights for unexplored paths based on known weights of previously evaluated path segments; identifying, by the one or more processors, a merge point where two or more candidate paths converge on a common intermediate asset; aggregating, by the one or more processors, assets from the two or more candidate paths at the merge point; and transmitting, by the one or more processors, execution instructions to the transaction network to execute a single combined exchange operation from the merge point to the target asset, thereby reducing a total number of exchange operation invocations on the transaction network compared to executing each candidate path independently.

Implementation 6. The computer-implemented method of implementation 5, wherein the transaction network comprises a blockchain network, the source asset and the target asset comprise cryptocurrency tokens, the exchange operations comprise token swap operations executed via smart contracts, and the per-invocation costs comprise gas fees.

Implementation 7. The computer-implemented method of implementation 5, wherein calculating the weights for the candidate paths further comprises: formulating an optimization problem as a knapsack problem in which a combination of path parts from multiple candidate nodes is selected subject to a constraint that a total number of selected parts equals the route parts parameter; and applying a mutual exclusivity constraint such that for each candidate node, at most one part allocation is selected.

Implementation 8. The computer-implemented method of implementation 5, further comprising: recursively deepening into a subgraph of the directed graph data structure to obtain actual weights for intermediate nodes; updating predicted weights of parent nodes based on the actual weights obtained from the recursive deepening; and re-evaluating an optimal path selection based on the updated predicted weights.

Implementation 9. The computer-implemented method of implementation 5, further comprising: detecting a conflict where two or more candidate paths require use of a same hop having limited exchange venue availability; selecting a path with a highest weight among the conflicting paths; confirming the selected path by storing distribution details for each hop in the selected path; and restarting a path selection algorithm with remaining route parts while accounting for confirmed hop distributions.

Implementation 10. The computer-implemented method of implementation 9, wherein storing distribution details for each hop comprises storing hop input asset quantity, hop output asset quantity, per-operation cost incurred, and exchange venues used.

Implementation 11. The computer-implemented method of implementation 5, further comprising: performing a merge operation by combining an input amount from a first path with an input amount from a second path at a shared hop; calculating a combined distribution for the merged input amounts; subtracting a previously-confirmed output from a new output to determine a net asset yield; and subtracting confirmed per-operation costs from current per-operation costs, wherein per-operation costs for exchange venues already invoked in a confirmed hop are not counted again.

Implementation 12. The computer-implemented method of implementation 5, further comprising: implementing a held exchange by temporarily holding assets at the merge point while monitoring transaction confirmations for the two or more candidate paths on the transaction network; determining when sufficient assets have arrived at the merge point from the two or more candidate paths; and proceeding with the single combined exchange operation upon determining that sufficient assets have arrived.

Implementation 13. The computer-implemented method of implementation 5, wherein computing predicted weights for intermediate nodes comprises applying a price up parameter to account for uncertainty in capacity availability, and wherein computing actual weights for the target asset comprises calculating asset outputs without applying the price up parameter.

Implementation 14. The computer-implemented method of implementation 13, wherein the price up parameter is dynamically adjusted based on at least one of: historical accuracy of predicted weights for similar exchange volumes, historical accuracy of predicted weights for similar asset pairs, capacity depth of an intermediate node, or volatility of an asset represented by an intermediate node.

Implementation 15. The computer-implemented method of implementation 5, wherein the one or more computational acceleration techniques reduce computation time to enable identification and execution of optimized paths within time constraints imposed by block times and changing market conditions on the transaction network.

Implementation 16. A system for reducing per-invocation costs in multi-path digital asset exchange operations on a transaction network, the system comprising: one or more processors; and a non-transitory computer-readable memory storing instructions that, when executed by the one or more processors, cause the system to: receive an exchange request specifying a source asset, a target asset, and an exchange quantity; generate a graph representation of available exchange paths, wherein the graph representation comprises nodes representing assets and edges representing exchange operations, each edge associated with exchange rate data and per-operation cost data for one or more exchange venues; apply a graph traversal algorithm to identify a plurality of candidate paths from the source asset to the target asset, wherein the graph traversal algorithm prioritizes exploring paths with highest predicted weights; apply one or more computational acceleration techniques comprising at least one of a predictor algorithm that predicts path outcomes to reduce a number of full path evaluations, or a dynamic weight algorithm that updates weights for unexplored paths based on known weights of previously evaluated path segments; identify one or more merge points where selected candidate paths share a common intermediate asset; generate execution instructions that aggregate assets from multiple selected candidate paths at each merge point and execute a merged exchange operation from each merge point; and transmit the execution instructions to the transaction network for execution.

Implementation 17. The system of implementation 16, wherein the transaction network comprises a blockchain network, the source asset and the target asset comprise cryptocurrency tokens, the exchange operations comprise token swap operations executed via smart contracts, and the per-operation costs comprise gas fees.

Implementation 18. The system of implementation 16, wherein the instructions further cause the system to: calculate predicted weights for intermediate nodes using a formula comprising an asset amount in baseline equivalent minus per-operation costs for exchange venue usage multiplied by a price up parameter; and calculate actual weights for the target asset using the asset amount in baseline equivalent minus per-operation costs without applying the price up parameter.

Implementation 19. The system of implementation 16, wherein the instructions further cause the system to: detect when two or more selected candidate paths conflict for use of an exchange venue at a shared hop; confirm a highest-weight path among the conflicting paths by storing hop distribution data comprising input quantities, output quantities, per-operation costs, and exchange venue identifiers for each hop in the highest-weight path; recalculate weights for remaining paths accounting for the confirmed hop distribution data; and select additional paths from the remaining paths based on the recalculated weights.

Implementation 20. The system of implementation 16, wherein the instructions further cause the system to: implement a held exchange mechanism that temporarily holds assets at an intermediate node while awaiting assets from one or more other execution paths; monitor transaction confirmations on the transaction network indicating arrival of assets from the one or more other execution paths at the intermediate node; and implement a timeout mechanism such that if assets from a second path do not arrive within a configurable time threshold, the system proceeds with executing an exchange using only assets that have arrived or reroutes held assets along an alternative path.

Implementation 21. The system of implementation 16, wherein the instructions further cause the system to: determine a route parts parameter defining a number of portions into which the exchange quantity is to be divided; formulate a constrained optimization problem as a knapsack problem selecting a combination of path parts from candidate nodes subject to a total parts constraint requiring selected parts to sum to the route parts parameter; and apply a mutual exclusivity constraint requiring that at most one part allocation is selected per candidate node.

Implementation 22. The system of implementation 16, wherein the instructions further cause the system to: recursively deepen into selected paths to obtain actual weights by calculating asset outputs at the target asset; propagate actual weight information from child nodes to parent nodes to update predicted weights; and re-evaluate path selections based on the updated predicted weights.

Implementation 23. The system of implementation 16, wherein the instructions further cause the system to: perform a merge operation by combining input amounts from a first path and a second path at a shared hop; calculate a combined distribution for the merged input amounts; determine a net asset yield by subtracting a previously-confirmed output from a combined output; and determine an incremental per-operation cost by subtracting previously-confirmed per-operation costs from combined per-operation costs, wherein the incremental per-operation cost is zero when the combined distribution uses only exchange venues already invoked in a confirmed hop.

Implementation 24. The system of implementation 16, wherein the graph traversal algorithm comprises: prioritizing exploration of paths with highest predicted weights until actual weights are obtained by reaching the target asset; utilizing dynamic programming to determine a best combination for distributing parts to child nodes; and confirming paths with highest actual weights and restarting algorithm steps with remaining parts while accounting for confirmed hop distributions.

Implementation 25. The system of implementation 16, wherein the one or more computational acceleration techniques reduce total computation time to enable identification and execution of optimized exchange paths within time constraints imposed by blockchain block times and rapidly changing market conditions.

Implementation 26. The system of implementation 16, wherein the instructions further cause the system to: maintain confirmed path information for each node, wherein each node receives confirmed path information from a parent node and passes confirmed child path information to the parent node when a best combination among child nodes is found; and join confirmed distributions of a node and its child paths to a parent's confirmed distribution when the node and its child paths are all confirmed.

Implementation 27. The system of implementation 16, wherein the instructions further cause the system to: compare an expected per-operation cost savings from merging paths at a merge point versus a potential cost of delay including price movement risk during a hold period; and determine whether to hold assets at the merge point or proceed with independent execution based on the comparison.

Implementation 28. The system of implementation 16, wherein the instructions further cause the system to: implement a fallback strategy in which, if capacity conditions at a merge point deteriorate during a hold period, held assets are released and executed independently rather than waiting for a merge.

Implementation 29. The system of implementation 16, wherein the graph representation comprises edges associated with capacity limitations for specific exchange operations, and wherein the instructions further cause the system to select paths that optimize for per-operation cost consumption while being constrained by the capacity limitations.

Implementation 30. The system of implementation 16, wherein the instructions further cause the system to: split the exchange quantity into smaller portions and route the portions along multiple paths to reduce price impact at individual exchange venues; and merge the portions at one or more intermediate nodes to reduce total per-operation costs compared to executing each portion along independent paths.

### Computer System

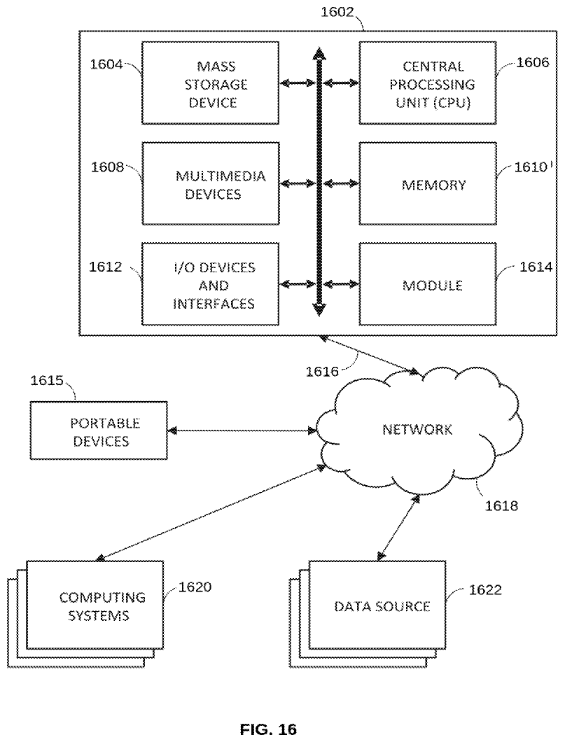

FIG. 16 is a block diagram 1600 depicting an embodiment of a computer hardware system 1602 configured to run software for implementing one or more of the systems and methods described herein. The example computer system 1602 is in communication with one or more computing systems 1620 and/or one or more data sources 1622 via one or more networks 1618. While FIG. 16 illustrates an embodiment of a computing system 1602, it is recognized that the functionality provided for in the components and modules of computer system 1602 may be combined into fewer components and modules, or further separated into additional components and modules.

The computer system 1602 can comprise a module 1614 that carries out the functions, methods, acts, and/or processes described herein. The module 1614 is executed on the computer system 1602 by a central processing unit 1606 discussed further below.

In general, the word “module,” as used herein, refers to logic embodied in hardware or firmware or to a collection of software instructions, having entry and exit points. Modules are written in a program language, such as JAVA, C or C++, PYTHON, or the like. Software modules may be compiled or linked into an executable program, installed in a dynamic link library, or may be written in an interpreted language such as BASIC, PERL, LUA, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within specially designed hardware or firmware. Not all calculations, analysis, and/or optimization require the use of computer systems, though any of the above-described methods, calculations, processes, or analyses may be facilitated through the use of computers. Further, in some embodiments, process blocks described herein may be altered, rearranged, combined, and/or omitted.

The computer system 1602 includes one or more processing units (CPU) 1606, which may comprise a microprocessor. The computer system 1602 further includes a physical memory 1610, such as random-access memory (RAM) for temporary storage of information, a read only memory (ROM) for permanent storage of information, and a mass storage device 1604, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system 1602 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 1602 includes one or more input/output (I/O) devices and interfaces 1612, such as a keyboard, mouse, touch pad, and printer. The I/O devices and interfaces 1612 can include one or more display devices, such as a monitor, which allows the visual presentation of data to a user. More particularly, a display device provides for the presentation of GUIs as application software data, and multi-media presentations, for example. The I/O devices and interfaces 1612 can also provide a communications interface to various external devices. The computer system 1602 may comprise one or more multi-media devices 1608, such as speakers, video cards, graphics accelerators, and microphones, for example.

The computer system 1602 may run on a variety of computing devices, such as a server, a Windows server, a Structure Query Language server, a Unix Server, a personal computer, a laptop computer, and so forth. In other embodiments, the computer system 1602 may run on a cluster computer system, a mainframe computer system and/or other computing system suitable for controlling and/or communicating with large databases, performing high volume transaction processing, and generating reports from large databases. The computing system 1602 is generally controlled and coordinated by an operating system software, such as z/OS, Windows, Linux, UNIX, BSD, SunOS, Solaris, MacOS, or other compatible operating systems, including proprietary operating systems. Operating systems control and schedule computer processes for execution, perform memory management, provide file system, networking, and I/O services, and provide a user interface, such as a graphical user interface (GUI), among other things.

The computer system 1602 illustrated in FIG. 16 is coupled to a network 1618, such as a LAN, WAN, or the Internet via a communication link 1616 (wired, wireless, or a combination thereof). Network 1618 communicates with various computing devices and/or other electronic devices, such as portable devices 1615. Network 1618 is communicating with one or more computing systems 1620 and one or more data sources 1622. The module 1614 may access or may be accessed by computing systems 1620 and/or data sources 1622 through a web-enabled user access point. Connections may be a direct physical connection, a virtual connection, and other connection type. The web-enabled user access point may comprise a browser module that uses text, graphics, audio, video, and other media to present data and to allow interaction with data via the network 1618.

Access to the module 1614 of the computer system 1602 by computing systems 1620 and/or by data sources 1622 may be through a web-enabled user access point such as the computing systems' 1620 or data source's 1622 personal computer, cellular phone, smartphone, laptop, tablet computer, e-reader device, audio player, or another device capable of connecting to the network 1618. Such a device may have a browser module that is implemented as a module that uses text, graphics, audio, video, and other media to present data and to allow interaction with data via the network 1618.

The output module may be implemented as a combination of an all-points addressable display such as a cathode ray tube (CRT), a liquid crystal display (LCD), a plasma display, or other types and/or combinations of displays. The output module may be implemented to communicate with interfaces 1612 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another embodiment, a user may interact with the system more directly such as through a system terminal connected to the score generator without communications over the Internet, a WAN, or LAN, or similar network.

In some implementations, the system 1602 may comprise a physical or logical connection established between a remote microprocessor and a mainframe host computer for the express purpose of uploading, downloading, or viewing interactive data and databases on-line in real time. The remote microprocessor may be operated by an entity operating the computer system 1602, including the client server systems or the main server system, an/or may be operated by one or more of the data sources 1622 and/or one or more of the computing systems 1620. In some implementations, terminal emulation software may be used on the microprocessor for participating in the micro-mainframe link.

In some implementations, computing systems 1620 who are internal to an entity operating the computer system 1602 may access the module 1614 internally as an application or process run by the CPU 1606.

In some implementations, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name, and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the creator. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

The computing system 1602 may include one or more internal and/or external data sources (for example, data sources 1622). In some implementations, one or more of the data repositories and the data sources described above may be implemented using a relational database, such as DB2, Sybase, Oracle, CodeBase, and Microsoft® SQL Server as well as other types of databases such as a flat-file database, an entity relationship database, and object-oriented database, and/or a record-based database.

The computer system 1602 may also access one or more databases 1622. The databases 1622 may be stored in a database or data repository. The computer system 1602 may access the one or more databases 1622 through a network 1618 or may directly access the database or data repository through I/O devices and interfaces 1612. The data repository storing the one or more databases 1622 may reside within the computer system 1602.

### CONCLUSION

In the foregoing specification, the systems and processes have been described with reference to specific embodiments thereof. It will, however, be evident that various modifications and changes may be made thereto without departing from the broader spirit and scope of the embodiments disclosed herein. The specification and drawings are, accordingly, to be regarded in an illustrative rather than restrictive sense.

Indeed, although the systems and processes have been disclosed in the context of certain embodiments and examples, it will be understood by those skilled in the art that the various embodiments of the systems and processes extend beyond the specifically disclosed embodiments to other alternative embodiments and/or uses of the systems and processes and obvious modifications and equivalents thereof. In addition, while several variations of the embodiments of the systems and processes have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the embodiments of the disclosed systems and processes. Any methods disclosed herein need not be performed in the order recited. Thus, it is intended that the scope of the systems and processes herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every embodiment.

It will also be appreciated that conditional language used herein, such as, among others, “can,” “could,” “might,” “may,” “for example,” and the like, unless specifically stated otherwise, or otherwise understood within the context as used, is generally intended to convey that certain embodiments include, while other embodiments do not include, certain features, elements and/or operations. Thus, such conditional language is not generally intended to imply that features, elements and/or operations are in any way required for one or more embodiments or that one or more embodiments necessarily include logic for deciding, with or without author input or prompting, whether these features, elements and/or operations are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the embodiments are not to be limited to the particular forms or methods disclosed, but, to the contrary, the embodiments are to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (for example, as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (for example, as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

What is claimed is:

1. A computer-implemented method for optimizing multi-path routing through a weighted directed graph data structure to reduce per-operation costs in a distributed transaction network, the method comprising:
receiving, by one or more processors, a routing request specifying a source node, a target node, and a quantity to be routed from the source node to the target node;
constructing, by the one or more processors, a directed graph data structure comprising a plurality of nodes and a plurality of edges connecting the nodes, wherein each edge is associated with one or more routing venues having capacity data and per-operation cost data;
determining, by the one or more processors, a route parts parameter that defines a number of portions into which the quantity is to be divided for routing through the directed graph data structure;
calculating, by the one or more processors, a weight for each of a plurality of candidate paths through the directed graph data structure, wherein calculating the weight comprises:
computing a predicted weight for each intermediate node based on a quantity amount converted to a baseline equivalent minus per-operation costs multiplied by a price up parameter that accounts for uncertainty in capacity availability at the intermediate node; and
computing an actual weight for the target node based on a quantity amount converted to the baseline equivalent minus per-operation costs without applying the price up parameter;
applying, by the one or more processors, one or more computational acceleration techniques comprising at least one of:
a predictor algorithm that predicts path outcomes based on patterns observed in previously evaluated paths to reduce a number of full path evaluations required; or
a dynamic weight algorithm that propagates weight information from evaluated path segments to unexplored paths sharing common segments to avoid redundant recalculation;
formulating, by the one or more processors, a constrained optimization problem as a knapsack problem in which a combination of path parts from multiple candidate nodes is selected subject to a constraint that a total number of selected parts equals the route parts parameter and a mutual exclusivity constraint such that for each candidate node at most one part allocation is selected;
recursively deepening, by the one or more processors, into selected paths to obtain actual weights by calculating outputs at the target node without the price up parameter;
propagating, by the one or more processors, actual weight information from child nodes to parent nodes to update predicted weights and re-evaluating path selections based on the updated weights;
identifying, by the one or more processors, one or more merge points where two or more selected candidate paths converge on a common intermediate node;
generating, by the one or more processors, execution instructions that aggregate quantities from the two or more selected candidate paths at each merge point and execute a single combined operation from each merge point; and
transmitting, by the one or more processors, the execution instructions to the distributed transaction network, wherein the execution instructions cause fewer operation invocations on the distributed transaction network than would be required to execute each selected candidate path independently.

2. The computer-implemented method of claim 1, further comprising:
detecting a conflict where two or more selected candidate paths require use of a same routing venue at a shared edge;
confirming a path with highest actual weight among the conflicting paths by storing distribution data for each hop in the confirmed path, the distribution data comprising input quantity, output quantity, per-operation cost incurred, and routing venue identifiers; and
restarting the constrained optimization problem for remaining route parts while incorporating the stored distribution data into weight calculations for paths sharing hops with the confirmed path.

3. The computer-implemented method of claim 1, further comprising:
implementing a held operation by temporarily holding a quantity at an intermediate node while monitoring transaction confirmations on the distributed transaction network indicating that a second execution path is progressing toward the intermediate node;
determining when sufficient quantity has arrived at the intermediate node from the second execution path; and
executing a combined operation from the intermediate node using aggregated quantities from converging execution paths.

4. A computer-implemented method for reducing per-invocation costs in multi-path digital asset exchange operations on a transaction network, the method comprising:
receiving, by one or more processors, an exchange request to exchange a quantity of a source asset for a target asset;
constructing, by the one or more processors, a directed graph data structure comprising nodes representing assets and edges representing exchange operations between assets, wherein each edge is associated with one or more exchange venues;
determining, by the one or more processors, a route parts parameter that defines a number of portions into which the quantity of the source asset is to be divided;
calculating, by the one or more processors, weights for candidate paths through the directed graph data structure, wherein calculating the weights comprises computing predicted weights for intermediate nodes and actual weights for the target asset;
applying, by the one or more processors, one or more computational acceleration techniques to reduce computation time for identifying the candidate paths, the one or more computational acceleration techniques comprising at least one of a predictor algorithm that predicts path outcomes or a dynamic weight algorithm that updates weights for unexplored paths based on known weights of previously evaluated path segments;
identifying, by the one or more processors, a merge point where two or more candidate paths converge on a common intermediate asset;
aggregating, by the one or more processors, assets from the two or more candidate paths at the merge point; and
transmitting, by the one or more processors, execution instructions to the transaction network to execute a single combined exchange operation from the merge point to the target asset, thereby reducing a total number of exchange operation invocations on the transaction network compared to executing each candidate path independently.

5. The computer-implemented method of claim 4, wherein the transaction network comprises a blockchain network, the source asset and the target asset comprise cryptocurrency tokens, the exchange operations comprise token swap operations executed via smart contracts, and the per-invocation costs comprise gas fees.

6. The computer-implemented method of claim 4, wherein calculating the weights for the candidate paths further comprises:
formulating an optimization problem as a knapsack problem in which a combination of path parts from multiple candidate nodes is selected subject to a constraint that a total number of selected parts equals the route parts parameter; and
applying a mutual exclusivity constraint such that for each candidate node, at most one part allocation is selected.

7. The computer-implemented method of claim 4, further comprising:
recursively deepening into a subgraph of the directed graph data structure to obtain actual weights for intermediate nodes;
updating predicted weights of parent nodes based on the actual weights obtained from the recursive deepening; and
re-evaluating an optimal path selection based on the updated predicted weights.

8. The computer-implemented method of claim 4, further comprising:
detecting a conflict where two or more candidate paths require use of a same hop having limited exchange venue availability;
selecting a path with a highest weight among the conflicting paths;
confirming the selected path by storing distribution details for each hop in the selected path; and
restarting a path selection algorithm with remaining route parts while accounting for confirmed hop distributions.

9. The computer-implemented method of claim 4, further comprising:
performing a merge operation by combining an input amount from a first path with an input amount from a second path at a shared hop;
calculating a combined distribution for the merged input amounts;
subtracting a previously-confirmed output from a new output to determine a net asset yield; and
subtracting confirmed per-operation costs from current per-operation costs, wherein per-operation costs for exchange venues already invoked in a confirmed hop are not counted again.

10. The computer-implemented method of claim 4, further comprising:
implementing a held exchange by temporarily holding assets at the merge point while monitoring transaction confirmations for the two or more candidate paths on the transaction network;
determining when sufficient assets have arrived at the merge point from the two or more candidate paths; and
proceeding with the single combined exchange operation upon determining that sufficient assets have arrived.

11. The computer-implemented method of claim 4, wherein the one or more computational acceleration techniques reduce computation time to enable identification and execution of optimized paths within time constraints imposed by block times and changing market conditions on the transaction network.

12. A system for reducing per-invocation costs in multi-path digital asset exchange operations on a transaction network, the system comprising:
one or more processors; and
a non-transitory computer-readable memory storing instructions that, when executed by the one or more processors, cause the system to:
receive an exchange request specifying a source asset, a target asset, and an exchange quantity;
generate a graph representation of available exchange paths, wherein the graph representation comprises nodes representing assets and edges representing exchange operations, each edge associated with exchange rate data and per-operation cost data for one or more exchange venues;
apply a graph traversal algorithm to identify a plurality of candidate paths from the source asset to the target asset, wherein the graph traversal algorithm prioritizes exploring paths with highest predicted weights;
apply one or more computational acceleration techniques comprising at least one of a predictor algorithm that predicts path outcomes to reduce a number of full path evaluations, or a dynamic weight algorithm that updates weights for unexplored paths based on known weights of previously evaluated path segments;
identify one or more merge points where selected candidate paths share a common intermediate asset;
generate execution instructions that aggregate assets from multiple selected candidate paths at each merge point and execute a merged exchange operation from each merge point; and
transmit the execution instructions to the transaction network for execution.

13. The system of claim 12, wherein the instructions further cause the system to:
calculate predicted weights for intermediate nodes using a formula comprising an asset amount in baseline equivalent minus per-operation costs for exchange venue usage multiplied by a price up parameter; and
calculate actual weights for the target asset using the asset amount in baseline equivalent minus per-operation costs without applying the price up parameter.

14. The system of claim 12, wherein the instructions further cause the system to:
detect when two or more selected candidate paths conflict for use of an exchange venue at a shared hop;
confirm a highest-weight path among the conflicting paths by storing hop distribution data comprising input quantities, output quantities, per-operation costs, and exchange venue identifiers for each hop in the highest-weight path;
recalculate weights for remaining paths accounting for the confirmed hop distribution data; and
select additional paths from the remaining paths based on the recalculated weights.

15. The system of claim 12, wherein the instructions further cause the system to:
implement a held exchange mechanism that temporarily holds assets at an intermediate node while awaiting assets from one or more other execution paths;
monitor transaction confirmations on the transaction network indicating arrival of assets from the one or more other execution paths at the intermediate node; and
implement a timeout mechanism such that if assets from a second path do not arrive within a configurable time threshold, the system proceeds with executing an exchange using only assets that have arrived or reroutes held assets along an alternative path.

16. The system of claim 12, wherein the instructions further cause the system to:
determine a route parts parameter defining a number of portions into which the exchange quantity is to be divided;
formulate a constrained optimization problem as a knapsack problem selecting a combination of path parts from candidate nodes subject to a total parts constraint requiring selected parts to sum to the route parts parameter; and
apply a mutual exclusivity constraint requiring that at most one part allocation is selected per candidate node.

17. The system of claim 16, wherein the instructions further cause the system to:
perform a merge operation by combining input amounts from a first path and a second path at a shared hop;
calculate a combined distribution for the merged input amounts;
determine a net asset yield by subtracting a previously-confirmed output from a combined output; and
determine an incremental per-operation cost by subtracting previously-confirmed per-operation costs from combined per-operation costs, wherein the incremental per-operation cost is zero when the combined distribution uses only exchange venues already invoked in a confirmed hop.

18. The system of claim 12, wherein the graph traversal algorithm comprises:
prioritizing exploration of paths with highest predicted weights until actual weights are obtained by reaching the target asset;
utilizing dynamic programming to determine a best combination for distributing parts to child nodes; and
confirming paths with highest actual weights and restarting algorithm steps with remaining parts while accounting for confirmed hop distributions.

19. The system of claim 12, wherein the instructions further cause the system to:
maintain confirmed path information for each node, wherein each node receives confirmed path information from a parent node and passes confirmed child path information to the parent node when a best combination among child nodes is found; and
join confirmed distributions of a node and its child paths to a parent's confirmed distribution when the node and its child paths are all confirmed.

20. The system of claim 12, wherein the instructions further cause the system to:
compare an expected per-operation cost savings from merging paths at a merge point versus a potential cost of delay including price movement risk during a hold period; and determine whether to hold assets at the merge point or proceed with independent execution based on the comparison.
